(19) United States
(12) Patent Application Publication
(10) Pub. No.: US 2026/0219354 A1
(43) Pub. Date: Jul. 30, 2026

(54) SYSTEMS AND METHODS FOR TRACKING AN INTERACTIVE OBJECT

(71) Applicant: Universal City Studios LLC, Universal City, CA (US)

(72) Inventors: Wei Cheng Yeh, Orlando, FL (US); Katelyn Wyatt, Orlando, FL (US); McKenna Schwartz, Orlando, FL (US)

(21) Appl. No.: 19/394,542

(22) Filed: Nov. 19, 2025

Related U.S. Application Data
(60) Provisional application No. 63/751,020, filed on Jan. 29, 2025.

(51) Int. Cl. G01S 5/02; G06F 3/01; G06F 3/0346; G06T 7/20

(52) U.S. Cl. CPC G01S 5/0294; G06F 3/016; G06F 3/0346; G06T 7/20; G06F 3/017

(57) ABSTRACT

An interactive object system includes processing circuitry comprising one or more processors and memory storing instructions, that when executed by the processing circuitry, cause the processing circuitry to receive, via one or more communication devices, tag data indicative of signal strength of radiofrequency signals transmitted by object communication circuitry of an interactive object, determine, via an identification model, a position of the interactive object in an interactive environment based on the tag data, and track, via the identification model, motion of the interactive object based on the tag data.

### CROSS-REFERENCE TO RELATED APPLICATION

This application claims priority from and the benefit of U.S. Provisional Application Serial No. 63/751,020, entitled “SYSTEMS AND METHODS FOR TRACKING AN INTERACTIVE OBJECT,” filed January 29, 2025, which is hereby incorporated by reference in its entirety for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

To improve guest experiences in an entertainment setting, the entertainment setting may often include objects (e.g., props or toys) that are interactive, provide special effects, or both. For example, the special effects may provide customized effects based on guests’ experiences within the entertainment setting, as well as support a particular narrative in the entertainment setting. In certain interactive entertainment settings, guests may own or be associated with objects that interact with the interactive entertainment setting in various ways. In one example, a guest may wish to interact with the interactive entertainment setting using a handheld device (e.g., an object) to generate a particular special effect.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In accordance with an embodiment, an interactive object system includes processing circuitry comprising one or more processors and memory storing instructions, that when executed by the processing circuitry, cause the processing circuitry to receive, via one or more communication devices, tag data indicative of signal strength of radiofrequency signals transmitted by object communication circuitry of an interactive object, determine, via an identification model, a position of the interactive object in an interactive environment based on the tag data, and track, via the identification model, motion of the interactive object based on the tag data.

In accordance with an embodiment, a method of operating an interactive object system includes receiving, at one or more processors and via one or more communication devices, tag data indicative of signal strength of radiofrequency signals transmitted by an object communication device of an interactive object and tracking, via the one or more processors and using an identification model, motion of the interactive object based on the tag data. The method of operating the interactive object system also includes providing, via the one or more processors, output instructions to generate one or more special effect outputs based on the motion of the interactive object.

In accordance with an embodiment, an interactive object system includes an interactive object having an object communication device, processing circuitry having one or more processors, and memory storing instructions. The instructions when executed by the processing circuitry, cause the processing circuitry to determine signal strength of radiofrequency signals transmitted by the object communication device of the interactive object and received at one or more communication devices in an interactive environment, input the signal strength of the radiofrequency signals into an identification model to track motion of the interactive object, and provide output instructions to generate one or more special effect outputs based on the motion of the interactive object.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of an interactive object system, in accordance with present techniques;

FIG. 2 is a schematic illustration of hardware components that may be used in an embodiment of the interactive object system of FIG. 1, in accordance with present techniques; and

FIG. 3 is a flow diagram of an embodiment of a process for detecting and tracking motion of an interactive object, in accordance with present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” “having,” and “based on” are intended to be inclusive and mean that there may be additional elements other than the listed elements. In addition, as used herein, the terms “real time,” “real-time,” “substantially real time,” and “substantially real-time” may be used interchangeably and are intended to describe operations (e.g., computing operations) that are performed without any human-perceivable interruption between operations. For example, as used herein, data relating to systems described herein may be collected, transmitted, and/or used in control computations in substantially real time such that data readings, data transfers, and/or data processing steps occur once every second, once every 0.1 second, once every 0.01 second, or even more frequent, during operations of the systems (e.g., while the systems are operating).

Users (e.g., guests) in an interactive environment (e.g., an immersive experience or an entertainment setting) may carry (e.g., hold and/or wear) objects (e.g., props; guest objects; interactive objects), such as carry handheld objects or wear costume elements. The objects may be associated with a theme and/or may include any of a variety of handheld and/or wearable objects, such as a sword, wand, token, medallion, toy, ball, headgear, figurine, stuffed animal, clothing (e.g., hat), jewelry (e.g., necklace, bracelet, band), container, other portable object, or any combination thereof.

The objects may be utilized to facilitate interactions with the interactive environment. For example, certain movements of an object may be detected as input to initiate a special effect (e.g., special effect output; display of imagery, such as animated characters; lighting; sounds; and/or haptic effects). Such interactions in the interactive environment may generally involve detection or recognition of the object inside the interactive environment (e.g., with a sensor and/or via wireless communication), as well as control of the object and/or special effect features in the interactive environment based on the detection or recognition of the object, based on the detection or recognition of a pattern associated with the object (e.g., movement or operation of the object; gesture), or the like. While feedback (e.g., special effects) related to the object may often be provided via components that are separate from the object within the interactive environment, present embodiments may also operate to provide feedback (e.g., special effects) from within or on the object, which may facilitate a deeper level of user immersion into the interactive environment.

As noted herein, the objects that may include any suitable type of interactive objects in any suitable form, including a form of a sword, wand, token, medallion, toy, ball, headgear, figurine, stuffed animal, clothing (e.g., hat), jewelry (e.g., necklace, bracelet, band), container, and so forth. Additionally, the objects may include on-board communication circuitry that, in operation, communicates object identification information and/or receives and sends wireless signals. Further, the objects may include one or more on-board emitters or any other suitable components to enable feedback (e.g., display of special effects) and interaction with the interactive environment.

Without the disclosed embodiments, identifying, locating, and/or tracking one object among many objects within a crowded interactive environment may be challenging. It may be desirable to identify the one object that corresponds to a user profile, and also to track movement of the one object within the interactive environment. Indeed, such identifying and tracking may facilitate unique interactions directly with the one object, such as in response to detected movement of the one object. For example, when a particular object is detected as performing a particular gesture, present embodiments may cause special effects to emit from the particular object and/or from a special effect feature in the interactive environment (e.g., a special effect feature near the particular object and/or being pointed at by the particular object). Similarly, mere detection of individual objects within the interactive environment may enable present embodiments to direct respective interactions (e.g., special effects) to each of the objects individually. Further, such directed respective interactions may be based on respective user profiles (e.g., respective user profiles including preferred special effect types) associated with the individual objects.

As described herein, identification and tracking methods may be utilized to facilitate directing special effects to individual objects and/or provide targeted special effects in the interactive environment based on interactive object movement within the interactive environment. To accomplish this, the interactive object system within the interactive environment may include a controller that may detect one or more objects using wireless communication techniques (e.g., electromagnetic radiation; radio frequency identification (RFID)) and may receive object identification information (e.g., unique identifiers) via signals (e.g., data; RF signals) communicated over a particular radio frequency (e.g., range). The controller may identify a best candidate object among the multiple objects based on a received signal strength of the signals that provide the object identification information, a user profile associated with the object identification information, and/or any other suitable selection criteria. In an embodiment, the controller 18 may track motion of the best candidate object using changes in received signal strength indication (RSSI), timing of signals, one or more additional changes to signals generated by wireless communication devices, or a combination thereof. In an embodiment, the controller may trigger one or more special effects based on the motion of the best candidate object (e.g., in response to the motion corresponding to a target movement, pattern, and/or gesture).

In an embodiment, the interactive object system may effectively tag the best candidate object as a target object of interest in image data and confirm a position of the target object of interest in the image data. Further, the interactive object system may continue to track motion of the best candidate object based on reflected light that is reflected by one or more detectable markers of the best candidate object and that is detected by one or more sensors (e.g., detectors; cameras). For example, the one or more sensors may detect the reflected light over time, which may indicate the motion of the best candidate object over time. Thus, the controller 18 may trigger the one or more special effects based on the motion of the best candidate object of interest over time.

The interactive environment may be part of a venue, such as an entertainment venue (e.g., an amusement park, an entertainment complex, a theatre, a sports stadium, a retail establishment, a residential building, a school, and so forth). In an embodiment, the interactive environment may be a live show, where the users are in an audience and may be able to participate in the live show using the objects. In an embodiment, the interactive environment may be a walk-through attraction or a ride attraction, where the users travel to experience different scenes and may be able to interact with the different scenes using the objects. The disclosed systems and methods may include at least one or more interactive environments in a themed area having a common theme. Further, the disclosed systems and methods may include additional or other interactive environments having different themes, but that are within the same theme park or entertainment venue. When referring to an interactive environment, the interactive environment may include a certain area of the theme park where users can interact with interactive elements within the certain area. Further, an interactive environment may also include different locations that are geographically separated from one another or that are dispersed throughout the theme park. The interactive environment may also be in a remote location. For example, the user may be able to establish an interactive environment at their home or any other location via an electronic device associated with the user (e.g., user electronic device; home console) that may interact with the object.

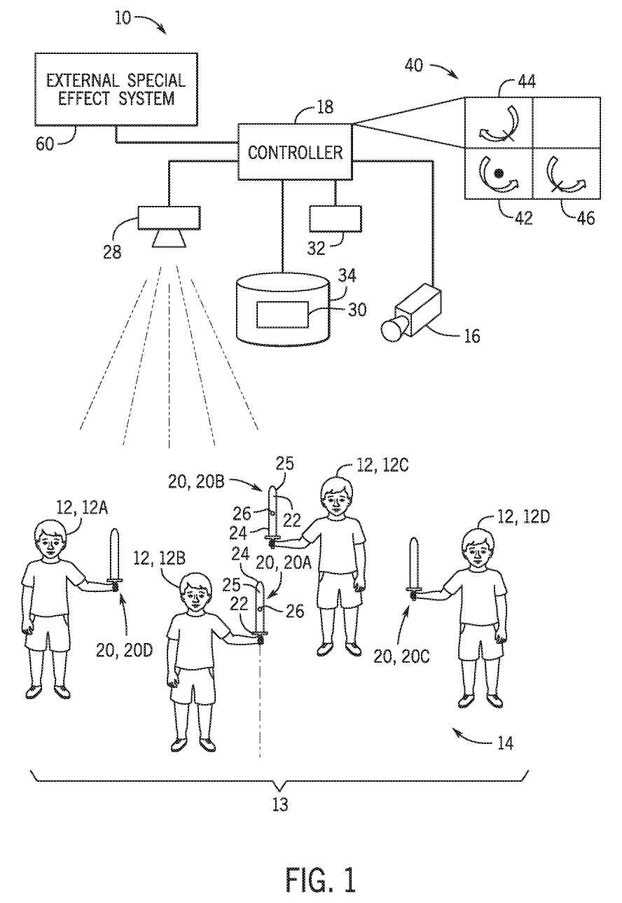

FIG. 1 is a schematic illustration of an embodiment of an interactive object system 10, in accordance with present techniques. In an embodiment, the interactive object system 10 may receive or detect interactive object identification information from one or more interactive objects 20 in an interactive environment 14. For example, each interactive object of the one or more interactive objects 20 may store and be configured to transmit a unique identifier (e.g., identification number). The interactive environment 14 may include an area 13 (e.g., interactive area) proximate to (e.g., within a communication range of) one or more detectors 16 (e.g., sensors, infrared (IR) cameras, visible light cameras) and/or one or more communication devices 32 (e.g., data transmission readers, radiofrequency (RF) readers; RF identification (RFID) readers). The one or more detectors 16 and/or the one or more communication devices 32 may be coupled to a controller 18. The controller 18 may control the one or more detectors 16 and the one or more communication devices 32. Additionally or alternatively, the controller 18 may control an external special effect system 60 based on signals received from the one or more detectors 16 and/or the one or more communication devices 32. For example, the interactive object system 10 may instruct the external special effect system 60 to generate audio and/or video effects to provide themed sounds, special effects, projections, or the like to enhance guest experiences.

In an embodiment, one or more users 12 may carry (e.g., hold and/or wear) the one or more interactive objects 20 in the interactive environment 14. For example, multiple users 12 and multiple interactive objects 20 may be present in the interactive environment 14, wherein each of the one or more users 12 carries a respective interactive object 20 (e.g., a first user 12A carries a first interactive object 20A, a second user 12B carries a second interactive object 20B, and so on). Each interactive object of the one or more interactive objects 20 may include a housing 22 that supports various components, such as an object communication circuitry 24 (e.g., transmission tag; RFID tag). The object communication circuitry 24 may store and be configured to transmit the unique identifier to the one or more communication devices 32. Additionally or alternatively, a signal strength of RF signals transmitted by the object communication circuitry 24 and received at the one or more communication devices 32 may be used by the controller 18 to determine a location and/or track movement of the interactive object 20. The housing 22 may also support a detectable marker 25 (e.g., retroreflector).

In an embodiment, the interactive object system 10 may detect presence of the one or more interactive objects 20 within the area 13 of the interactive environment 14 based on receiving respective RF signals that encode respective unique identifiers from respective object communication circuitry 24. In an embodiment, the object communication circuitry 24 may include one or more internal transmitters (e.g., active transmitters) that may continuously emit respective RF signals. In an embodiment, the object communication circuitry 24 may include one or more passive tags that may emit respective RF signals (e.g., backscatter) in response to receipt of interrogation signals (e.g., electromagnetic radiation; RF interrogation signals) from the one or more communication devices 32. In one embodiment, the one or more communication devices 32 may transmit interrogation signals with frequencies within any suitable range that corresponds to a receiver range of the one or more object communication circuitry 24 of the one or more interactive objects 20.

In an embodiment, the interactive object system 10 may detect presence of the one or more interactive objects 20 within the area 13 of the interactive environment 14 based on detecting light via the one or more detectors 16. For example, the interactive object system 10 may include one or more light emitters 28 that emit light (e.g., IR light, visible light) into the area 13. Thus, the light may be reflected (e.g., reflected light) by the retroreflector 25 of the one or more interactive objects 20 when the one or more interactive objects 20 are within the area 13, and the reflected light may be received at the one or more detectors 16. For example, the retroreflector 25 may reflect the light emitted by the light emitters 28 and the reflected light may be used to determine a position of the one or more interactive objects 20 in image data generated by the one or more detectors 16.

It should be appreciated that the interactive object system 10 may utilize the RF signals, the reflected light, or both to detect the presence of the one or more interactive objects 20 within the area 13 of the interactive environment 14. Further, the interactive object system 10 may utilize the RF signals, the reflected light, or both to determine the location and/or track the movement of the one or more interactive objects 20 within the area 13 of the interactive environment 14. For example, the interactive object system 10 may analyze the signal strength of the RF signals over time and the reflected light over time to track the movement the one or more interactive objects 20. In such cases, the reflected light over a period of time may indicate that one interactive object of the one or more interactive objects 20 successfully completed a particular movement (e.g., gesture; target movement). Further, over the period of time, a respective signal strength of a respective RF signal (which also encodes a respective unique identifier) for a particular interactive object of the one or more interactive objects 20 may also correspond to the particular movement. Thus, the interactive object system 10 may determine, based on both the reflected light and the signal strength of the RF signals, that the particular interactive object of the one or more interactive objects 20 successfully completed the particular movement.

In an embodiment, the particular object of the one or more interactive objects 20 may be associated with a respective user profile. For example, the interactive object system 10 may use the respective unique identifier to access the respective user profile and to update the respective user profile, such as to record an achievement (e.g., record successful completion of the particular movement). Additionally or alternatively, the interactive object system 10 may use the respective unique identifier to access the respective user profile and to control the external special effect system 60 based on information (e.g., preferences, achievements, past experiences) in the respective user profile, such as to display an animated character that corresponds to the preferences in the respective user profile.

In an embodiment, the interactive object system 10 may switch or alternate between techniques utilizing the RF signals, the reflected light, or both to detect the presence, determine the location, and/or track the movement of the one or more interactive objects 20 within the area 13 of the interactive environment 14 based on one or more factors, such as environmental factors (e.g., time of day, sunlight levels at the area 13, crowd levels at or nearby the area 13). For example, the interactive object system 10 may turn off the one or more light emitters 28 and/or block use of the reflected light for detection and/or tracking during occurrence of a particular environmental condition, such as a high light level (e.g., high sunlight level; absence of cloud cover; daytime hours) at the area 13, as the RF signals may be more reliable than the reflected light for tracking the one or more interactive objects 20 under the particular environmental condition. However, the interactive object system 10 may turn on the one or more light emitters 28 and/or enable use of the reflected light for detection and/or tracking during occurrence of a different particular environmental condition, such as a low light level (e.g., low sunlight level; cloud cover; nighttime hours) at the area 13. In an embodiment, the interactive object system 10 may receive an indication of an environmental condition from any suitable source (e.g., via one or more sensors that monitor environmental conditions at or near the area 13, such as one or more light sensors that monitor light levels in the area 13; a schedule and/or a clock, which may indicate daylight hours, nighttime hours, and/or current time of day; data services, such as weather services that provide weather data, including current or forecast weather data, such as cloud cover) and may dynamically select and/or adjust components utilized for detection and/or tracking of the one or more interactive objects 20 based on the environmental condition. In this way, the interactive object system 10 may maintain reliable detection and/or tracking of the one or more interactive objects 20 over time.

Certain operational features of the interactive object system 10 may be more readily understood and appreciated with reference to and discussion of an example with only a single interactive object 20 in the area 13. In operation with the single interactive object 20 in the area 13, the object communication circuitry 24 may be within range of the one or more communication devices 32. As such, the object communication circuitry 24 may provide RF signals that encode a unique identifier for the single interactive object 20 to the one or more communication devices 32. The one or more communication devices 32 may provide one or more indications of signal strength of the RF signals and the unique identifier to the controller 18. In an embodiment, the controller 18 may use the one or more indications of signal strength of the RF signals to estimate a location of the single interactive object 20 in the area 13. For example, certain signal strength values (e.g., ranges; combinations) may indicate that the location of the single interactive object 20 in the area 13 corresponds to a target location in the area 13 (e.g., in front of a display or other feature of the external special effect system 60).

In an embodiment, the controller 18 may receive and analyze the one or more indications of signal strength of the RF signals over a period of time (e.g., 3, 5, 10, or more seconds). Further, the controller 18 may use the one or more indications of signal strength of the RF signals over the period of time to predict interest (e.g., intent to interact with the interactive object system 10; select or confirm the single interactive object 20 as a best candidate interactive object) of the respective user 12 with the single interactive object 20 and/or to track movement (e.g., gesture) of the single interactive object 20. For example, the signal strength of the RF signals over the period of time may indicate that the single interactive object 20 is carried in a certain manner (e.g., quickly; directly, such as in a straight path) toward the target location. Thus, the controller 18 may predict that the single interactive object 20 will subsequently be manipulated by the respective user 12 in an attempt to interact with the interactive object system 10 (e.g., to cause the external special effect system 60 to output special effects).

In an embodiment, the controller 18 may then continue to receive and analyze the one or more indications of signal strength of the RF signals to track the movement of the single interactive object 20. For example, certain patterns of signal strength may correspond to (e.g., be counted as) particular movements (e.g., a first pattern corresponds to a first target movement, a second pattern corresponds to a second target movement, and so on) of the single interactive object 20. As described herein, the controller 18 may utilize artificial intelligence (e.g., trained artificial intelligence algorithms or models), such as to determine successful completion of particular movements based on the one or more indications of signal strength.

In an embodiment, the controller 18 may then additionally or alternatively utilize the reflected light to track the single interactive object 20. For example, the controller 18 may instruct the one or more light emitters 28 to emit light and/or receive the reflected light from the one or more detectors 16. The controller 18 may identify and/or confirm that the reflected light originates from the target location (e.g., from the single interactive object 20), such as by referencing a coordinate system (e.g., grid; mapped to the area 13; calibrated with the one or more communication devices 32 and the one or more detectors 16). Then, the controller 18 may continue to receive and analyze the reflected light to track the movement of the single interactive object 20. As set forth herein, certain patterns of the reflected light may correspond to (e.g., be counted as) particular movements (e.g., a first pattern corresponds to a first target movement, a second pattern corresponds to a second target movement, and so on) of the single interactive object 20. As described herein, the controller 18 may utilize artificial intelligence (e.g., trained artificial intelligence algorithms or models), such as to determine successful completion of particular movements based on the reflected light and/or the one or more indications of signal strength.

The interactive object system 10 may implement additional or alternative techniques to facilitate interactive experiences. As set forth herein, the controller 18 may switch or alternate between use of the one or more indications of signal strength of the RF signals and the reflected light. For example, the controller 18 may utilize the one or more indications of signal strength to predict the interest of the respective user 12 and to identify that the single interactive object 20 reaches the target location and then switch to use the reflected light to track the movement of the single interactive object 20. As another example, the controller 18 may utilize the one or more indications of signal strength to track the movement of the single interactive object 20 under a first environmental condition(s), such as bright light conditions and/or high crowd conditions that may interfere with light detection at the one or more detectors 16 (e.g., due to ambient light interference and/or obstruction of line of sight). However, the controller 18 may utilize the reflected light to track the movement of the single interactive object 20 under a second environmental condition(s), such as low light conditions, low crowd conditions, and/or high electromagnetic interference conditions that may support light detection at the one or more detectors 16 and/or interfere with transmission of the RF signals. The interactive object system 10 may receive signals indicative of the environmental conditions from any suitable source(s), such as one or more sensors at or near the area 13, data services (e.g., weather service), a clock (e.g., time of day clock), and so forth. Further, the controller 18 may utilize both the one or more indications of signal strength and the reflected light as a default operation, but may switch (e.g., turn off the one or more light emitters 28; block processing of one or more indications of the signal strength or the reflected light) to one or the other based on the environmental conditions. Additionally, the controller 18 may not necessarily switch to one or the other, but instead may select one or the other as a preferred source upon identifying inconsistent data (e.g., use the one or more indications of the signal strength when inconsistent with the reflected light in presence of high crowd levels).

As noted herein, the interactive object system 10 may implement additional or alternative techniques to facilitate interactive experiences, such as techniques to individually address or confirm the single interactive object 20. The controller 18 may carry out a write/read process to confirm presence of the single interactive object 20 (e.g., confirm that the single interactive object 20 is present and reachable via the one or more communication devices 32). For example, in response to receipt of the one or more indications of the signal strength of the RF signals that encode the unique identifier, the controller 18 may select and/or identify the single interactive object 20 as a best candidate interactive object (e.g., because the controller 18 predicted the interest and/or identified the single interactive object 20 at the target location). Then, the controller 18 may send a write signal to write a confirmation indicator to the object communication circuitry 24 (e.g., to memory of the RFID tag; targeted or object-specific based on the unique identifier). Then, the controller 18 may request and/or receive a read signal from the one or more communication devices 32 to confirm whether the confirmation indicator is stored with the unique identifier on the single interactive object 20. When the controller 18 is able to confirm that the confirmation indicator is stored with the unique identifier on the single interactive object 20, then the controller 18 may assign any achievement to a user profile associated with the unique identifier (e.g., with a higher confidence level, as compared to techniques without the write/read process). The controller 18 may retrieve or access the user profile associated with the unique identifier (e.g., from a database 34).

It should be appreciated that the controller 18 may send an object-specific command based on the unique identifier to cause the single interactive object 20 to send other transmission data (e.g., not actively written to the single interactive object 20 in the area 13; stored in the memory of the RFID tag prior to use in the area 13) via the object communication circuitry 24 (e.g., the object-specific command to the first interactive object 20A would cause the object communication circuitry 24 of the first interactive object 20A to send transmission data other than the unique identifier, but would not cause the object communication circuitry 24 of the second interactive object 20B to send transmission data). Then, if the one or more communication devices 32 receive the transmission data sent by the object communication circuitry 24, the controller 18 may determine (e.g., confirm) that the single interactive object 20 in the area 13 is properly identified.

In an embodiment, the controller 18 may send an object-specific command based on the unique identifier to cause an object output that is detectable by the one or more communication devices 32 (e.g., results in a change in the signal strength of the RF signals). For example, the controller 18 may send the object-specific command to instruct and to cause the single interactive device 20 to vibrate via one or more haptic devices 26 on the single interactive device 20. Such vibrations may cause a change in the signal strength of the RF signals, which may then be analyzed by the controller 18 to determine and to confirm that the single interactive object 20 in the area 13 is properly identified. Advantageously, the vibrations may also be sensed by the respective user 12 and may alert or notify the respective user 12 that they have been selected by the interactive object system 10 to proceed with an interactive experience.

In an embodiment, one or more special effects provided in the interactive environment 14 during operation of the single interactive object 20 in the area 13 may account for details in the user profile. For example, the one or more special effects may be based on user profile information, such as: accomplishments (e.g., achievements), including accomplishments due to actions performed by one or more users in the interactive environment 14 and/or actions carried out using the single interactive object 20; user experience levels; past user locations; past object locations; past user experiences; user preferences, such as preferred characters and/or preferred colors; user information, such as age and/or height; or any combination thereof. In an embodiment, the accomplishments may include a total of points awarded and saved to the user profile, such as due to the actions performed by the one or more users in the interactive environment 14 and/or actions carried out using the single interactive object 20. For example, the special effects may include display of certain characters preferred by the user according to the user profile. Additionally, accomplishments (e.g., points) awarded due to actions within the interactive environment 14 may be saved to the user profile, and thus, the user profile may be updated over time. As shown, the interactive object system 10 may include the external special effect system 60, which may provide special effects (e.g., special effect outputs). The special effects may include displayed outputs, audio outputs, lighting outputs, flame effects, animated figures, and so forth. For example, the displayed outputs may include display of media, such as characters, scenery, and so forth. As another example, the animated figures may include actuatable characters and/or objects that include actuators to drive movement of the animated figures (or portions thereof) relative to the interactive environment 14.

Techniques described herein with respect to the single interactive object 20 may be implemented with multiple interactive objects 20 in the area 13 (e.g., the multiple interactive objects 20 may include one or more entering the area 13, one or more leaving the area 13, one or more moving within the area 13, and/or one or more stationary within the area 13). For example, with the multiple interactive objects 20 in the area 13 as shown in FIG. 1, the controller 18 may receive one or more indications of respective signal strength of respective RF signals from the multiple interactive objects 20. The controller 18 may select a particular interactive object 20 of the multiple interactive objects 20 as a best candidate interactive object based on the one or more indications of respective signal strength of respective RF signals from the multiple interactive objects 20. For example, the controller 18 may select the particular interactive object 20 based on certain patterns in the respective signal strength, such as certain patterns in the respective signal strength indicating that the respective user 12 of the particular interactive object 20 carries the particular interactive object 20 toward the target location and/or maintains the particular interactive object 20 at the target location (e.g., for a threshold dwell time at the target location). The controller 18 may also disregard or reject one of more other interactive objects of the multiple interactive objects 20 based on the respective signal strength of respective RF signals of the one or more other interactive objects failing to match the certain patterns and/or matching other patterns associated with lack of interest or intent to interact with the interactive object system 10. In an embodiment, the controller 18 may also consider other factors, such as respective user profiles associated with the multiple interactive objects 20 to select the best candidate interactive object. For example, the controller 18 may identify two interactive objects of the multiple interactive objects 20 at the target location, and the controller 18 may select the particular interactive object 20 based on the respective user profiles (e.g., select the particular interactive object 20 associated with more achievements, fewer achievements, younger age, older age, and so forth). As noted herein, the controller 18 may implement confirmation and/or notification operations, such as object-specific write/read processes and/or object-specific outputs (e.g., vibrations). Further, the controller 18 may then proceed to track the movement of the particular interactive object 20 based on the respective signal strength of the respective RF signals and/or the reflected light captured by the one or more detectors 16, as described herein. This may enable one or more special effects to be directed to the particular interactive object 20 (e.g., on-board the particular interactive object 20, such as vibrations, lights, and/or sounds) and/or the external special effect system 60 in the interactive environment 14 based on the movement of the particular interactive object 20 and/or the user profile associated with the particular interactive object 20.

In order to correlate certain activities with outputs (e.g., special effects), present embodiments may associate particular activities with particular interactive objects of the one or more interactive objects 20 based on certain detectable criteria. For example, in attempting to identify a particular interactive object of the one or more interactive objects 20 that performed a particular gesture, the controller 18 may receive the object identification information detected for the one or more interactive objects 20 and may retrieve one or more user profiles that correspond to the identification information (e.g., unique identifier) of the one or more interactive objects 20.

Further, tag data (e.g., respective signal strength of respective RF signals; generated by the object communication circuitry 24) may indicate a position of the particular interactive object 20 in the area 13. For example, the position may include an approximate position or coordinates in a grid 40 mapped to the area 13, such as an X (row) and Y (column) coordinate within a 4x4 grid, 8x8 grid, 16x16 grid, 32x32 grid, and so on. Thus, the controller 18 may process the tag data to determine the position of the particular interactive object 20 in the area 13 (e.g., creating and/or storing the position, such as by generating and/or recording the coordinates relative to the grid 40). In an embodiment, the object communication circuitry 24 may include an RFID tag that may transmit signals over different and/or multiple frequencies (e.g., 3 to 300 kilohertz (kHz), 800-100 megahertz (MHz), and the like), which may facilitate detection and confirmation of the particular interactive object 20. The controller 18 may identify the particular interactive object 20 as a best candidate interactive object among multiple interactive objects 20 based on one or more characteristics of the RF signals received from the particular interactive object 20, such as the signal strength of the RF signals received at the one or more communication devices 32 (e.g., the signal strength of the RF signals over time).

The controller 18 may utilize one or more identification models 30 (e.g., artificial intelligence algorithms or models; trained models) to identify the particular interactive object 20 as the best candidate interactive object among the multiple interactive objects 20. For example, the one or more identification models 30 may be trained on training data (e.g., a training data set) that includes signal strength of sample signals received from one or more sample interactive objects over time as the one or more sample interactive objects move through the interactive environment 14 and/or other environments. In an embodiment, the training data may include sample signals received from the one or more sample interactive objects positioned at one or more established input locations. The established input locations may be related to an expected position of a best candidate interactive object. More specifically, signal strength may be correlated to respective distances from an associated communication device 32. Thus, the signal strength and/or the respective distances may be analyzed by the controller 18 to carry out any operations described herein, such as to identify the best candidate interactive object of the multiple interactive objects 20. For example, various RF signals (or the signal strength of the RF signals over time) may be used as inputs to the one or more identification models 30 to identify the best candidate interactive object.

In an embodiment, the one or more identification models 30 may be used to facilitate calibration between the one or more communication devices 32 and the one or more detectors 16 (e.g., both relative to the grid, which generally represents or provides a shared reference and/or a shared coordinate system). Calibration may be used to enable respective positions of the multiple interactive objects 20 to be determined based on the detection of the respective RF signals transmitted by the respective object communication circuitry 24 of the multiple interactive objects 20 within the interactive environment 14. Thus, the calibration may also be used to enable the respective position of the best candidate interactive object to be determined based on the detection of the respective RF signals transmitted by the respective object communication circuitry 24 of the best candidate interactive object. Further, the calibration may also be used to track movement of the multiple interactive objects 20, or at least movement of the best candidate interactive object.

In an embodiment, the controller 18 may receive the unique identifier and the tag data indicative of the position of the best candidate interactive object in the interactive environment 14. Then, the controller 18 may efficiently and reliably track the best candidate interactive object via the reflected light (e.g., tagged in image data generated by the one or more detectors 16 based on the position relative to the grid 40 as derived from the tag data), identify successful or complete movements (e.g., target movements; gestures) performed with the best candidate interactive object, assign accomplishments to the user profile and/or otherwise update the user profile information in the user profile, provide personalized special effects based on the user profile, and so forth. In addition to or as an alternative to the reflected light, in order to track motion of the best candidate interactive object, the controller 18 may evaluate the signal strength of the RF signals over time provided by the tag data. For example, the one or more identification models 30 may be used to identify movements and/or other motions of the best candidate interactive object based on signal strength over time, as the signal strength over time is indicative of a change in position of the best candidate interactive object in the interactive environment 14.

In an embodiment, the one or more identification models 30 may be machine learning or artificial intelligence (AI) models and may be trained on training data. The training data may be indicative of position (e.g., distance) and/or motion of at least one of the one or more interactive objects 20 and/or one or more test interactive objects within the interactive environment 14 and/or a simulated environment. The training data may include RF signals (or characteristics of the signals, such as the signal strength of the signals over time). The training data may be generated via robotics (e.g., animated figures; robotic figures). For example, the training data may be generated by controlling one or more robotic arms to move the one or more test interactive objects. For example, the training data may be generated by controlling a robotic arm to move a particular test interactive object to perform a target motion (e.g., a swirl or shape in air), and the signal strength of the RF signals over time as output by a respective object communication circuitry of the particular test interactive object and received at a respective communication device may be recorded as corresponding to the target motion. Such training may be repeated and performed multiple times, including by the robot, additional robots, for the target motion, and/or for additional target motions. Such training may be used to train the one or more identification models 30 to identify respective patterns in various inputs of signal strength of RF signals over time. Additionally or alternatively, such training may be used to train the one or more identification models 30 to identify performance of respective target motions based on various inputs of signal strength of RF signals over time. Further, such training may be implemented to train the one or more identification models 30 to identify position (e.g., relative to respective communication devices), to predict interest or intent of a respective user (e.g., signal strength of RF signals while approaching or at a target location), select a best candidate interactive object (e.g., based on the patterns, the motion, the position, and/or the predicted interest or intent), and so forth.

Additionally or alternatively, the training data may include data collected over time during interactions of the one or more users 12 with the one or more interactive objects 20 within the interactive environment 14, one or more additional interactive objects, and the like. In this way, the one or more identification models 30 may be used to monitor the interactions as described herein, and the one or more identification models 30 may also be updated (e.g., refined) over time based on the interactions. Additionally or alternatively, the training data may be synthetic data and/or simulated data. The synthetic data may be generated using machine learning techniques and may be used in addition to or instead of real-world data. The simulated data may be generated using one or more computer-generated models that may correspond to a physical motion of an interactive object by a user. As such, the training data may include data generated by robotics, real-world data collection, synthetic data generation, simulated data generation, or a combination thereof. In an embodiment, noise may be added to the training data to ensure the training data may train the one or more identification models 30 to account for sources of noise in the interactive environment 14. For example, noise such as environmental noise, electromagnetic interference noise, and the like may be added to the training data. In other embodiments, the one or more identification models 30 may be trained to filter out noise present in real-world data during data analysis.

In an embodiment, the one or more identification models 30 may be trained using the training data to predict and identify motion of the one or more interactive objects 20 within the interactive environment 14 based on one or more patterns (e.g., in the signal strength of the RF signals). The one or more patterns may trigger one or more special effects, award one or more achievements (e.g., points), and the like to improve immersive experiences of the one or more users 12 within the interactive environment 14. For example, the database 34 may include one or more patterns (e.g., in signal strength of RF signals) corresponding to one or more motions (e.g., movements, gestures) and/or one or more actions (e.g., special effects, achievements) to be triggered upon completion of the one or more patterns and/or the one or more motions by the interactive object 20. For example, the training data may be used to train the one or more identification models 30 to identify the one or more patterns and associate the one or more patterns with the one or more actions. As such, the one or more identification models 30 may be used to analyze the tag data generated by the interactive object system 10 via communication between the object communication circuitry 24 and the one or more communication devices 32 and trigger one or more actions of the external special effects system 60 and/or on-board the one or more interactive objects 20. For example, the one or more identification models 30 may determine that the tag data transmitted from a particular interactive object 20 is indicative of a first pattern that corresponds to a first special effect via the external special effect system 60. As such, the interactive object system 10 may trigger activation of the first special effect in response to identification of the first pattern. The first pattern may include one or more changes in signal strength and/or certain patterns of signal strength over time as identified by the one or more identification models 30.

In an embodiment, the one or more identification models 30 may be designed to account for one or more types of noise (e.g., environmental noise, cross interference, signal reflection) that may be present in the interactive environment 14 during real-world use of the one or more interactive objects 20. For example, the types of noise may include environmental noise due to presence of one or more devices (e.g., phones, tablets, watches, Bluetooth enabled devices) transmitting signals within the interactive environment 14. The one or more identification models 30 may also account for interruptions in the signals due to interruption in signal transmission between the one or more object communication circuitry 24 of the one or more interactive objects 20 and the one or more communication devices 32. Such interruptions may be due to presence of humans, metals, containers of liquid (e.g., drinks), cross interference due to one or more additional wireless signals (e.g., Wi-Fi, Bluetooth), or a combination thereof impacting transmission between the one or more object communication circuitry 24 and the one or more communication devices 32. For example, the one or more identification models 30 may filter out one or more frequency spectrums used by known interference devices within the interactive environment 14.

In an embodiment, the one or more identification models 30 may be used to analyze tag data to identify the best candidate interactive object, such as based on a pattern indicative of signal strength above a threshold level (e.g., at a particular time and/or for at least a threshold period of time), relative received signal strength (e.g., at a particular time and/or for at least a threshold period of time), and the like. For example, the best candidate interactive object may correspond to a particular interactive object of the one or more interactive objects 20 that emits a signal having a highest received signal strength indicator (RSSI) value over time and/or certain patterns in the RSSI value over time, wherein the RSSI value indicates an amount of power present in a signal as received at the one or more communication devices 32. A position and/or movement of the best candidate interactive object may be tracked based on the signal strength (e.g., indicative of estimated proximity to the one or more communication devices 32), and in some cases the signal strength over time. For example, two interactive objects of the one or more interactive objects 20 may be within a communication range of the one or more communication devices 32, but one of the two interactive objects of the one or more interactive objects 20 may be closer in proximity to the one or more communication devices 32 or may be positioned to provide a respective signal strength within a threshold range (e.g., having a maximum and minimum; non-zero) for more than a threshold period of time (e.g., demonstrates a dwell time within the threshold range). For example, to facilitate discussion, considering a scale of 1 to 10 (e.g., correlating to a range of RSSI values, such as -60 to -30), the one of the two interactive objects of the one or more interactive objects 20 may have a respective signal strength that remains within a threshold range of 3 to 6 for more than a threshold period of time of 3 seconds, while the other of the two interactive objects of the one or more interactive objects 20 may have a respective signal strength that is only within the threshold range of 3 to 6 for less than the threshold period of time or remains outside of the threshold range. Additionally or alternatively, motion of the best candidate interactive object may be tracked based on certain patterns in the signal strength over time to identify that the respective user 12 intends to interact with an interactive feature and/or is properly positioned to interact with the interactive feature of the interactive environment 14, for example.

In an embodiment, with reference to the grid 40 of FIG. 1, the controller 18 may determine that the first interactive object 20A is in a first portion 42 (e.g. cell) of the grid 40 based on signal strength of the RF signal from the object communication circuitry 24 of the first interactive object 20A (e.g., based on the tag data). Thus, the controller 18 may associate signals (e.g., the RF signal and/or reflected light) originating in the first portion 42 of the grid 40 with the first interactive object 20A, and the controller 18 may not associate signals (e.g., RF signals and/or reflected light) originating in other portions (e.g., cells) of the grid 40 with the first interactive object 20A. Further, in an embodiment, the controller 18 may determine that the second interactive object 20B is in a second portion 44 of the grid 40 based on detecting the RF signal from the object communication circuitry 24 of the second interactive object 20B (e.g., based on the tag data). Thus, the controller 18 may associate signals (e.g., the RF signal and/or reflected light) originating in the second portion 44 of the grid 40 with the second interactive object 20B, and the controller 18 may not associate signals (e.g., RF signals and/or reflected light) originating in other portions of the grid 40 with the second interactive object 20B. For example, the RF signal and/or the reflected light originating in a third portion 46 of the grid 40 may be due to presence of a third interactive object 20C. However, the controller 18 may disregard the signals originating in the third portion 46 of the grid 40 if the third interactive object 20C has not yet been identified as the best candidate interactive object and/or has not yet been tagged (e.g., based on the tag data) by the interactive object system 10. Further, a fourth interactive object 20D may be located outside of the area 13 (e.g., outside of the range of the one or more communication devices 32 and/or outside of the field of view of the one or more detectors 16), and the fourth interactive object 20D may not be identified and/or tracked while located outside of the area 13.

It should be appreciated that certain steps may be carried out simultaneously and/or at overlapping times. For example, the controller 18 may receive and/or process the signal strength of the RF signals and the reflected light simultaneously or sequentially (e.g., to identify the best candidate interactive object, position, patterns, and/or movement).

The one or more interactive objects 20 may have any suitable power source to facilitate techniques described herein. In an embodiment, the one or more interactive objects 20 may be charged, such as via wireless charging techniques (e.g., power harvesting techniques). For example, the wireless charging techniques may include mid-range to long-range charging methods, such as via charging over ultra-high frequency (UHF) radio frequencies and/or charging using near-field communication (NFC) methods. For example, the one or more interactive objects 20 may include one or more NFC coils located in respective interior portions (e.g., a distal tip; opposite end from a handle) of the one or more interactive objects 20. The NFC coil may facilitate charging and/or power boosting for the respective interactive object of the one or more interactive objects 20 by gaining charge via transmission of energy from an external device, such as an external device associated with the user 12 (e.g. mobile phone, NFC charger, which may be implemented as a toy or wearable device). The external device may include a holster and/or holder for the one or more interactive objects 20 so that the one or more interactive objects 20 may charge as the user 12 moves throughout the interactive environment 14. In an embodiment, the one or more interactive objects 20 may also include an on-board power source (e.g. rechargeable and/or replaceable battery or super capacitor) that may buffer and store energy, such as energy from the one or more communication devices 32, an electronic device associated with the user 12 (e.g., user’s electronic device), an accessory that is used with the one or more interactive objects 20, and so forth. The on-board power source may facilitate provision of effects even when power from an external power source is not present.

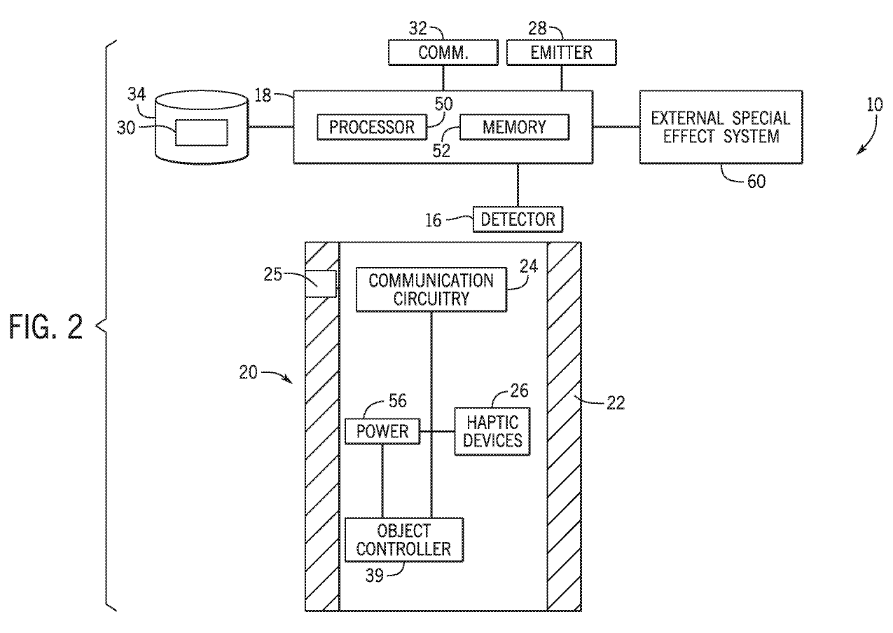

FIG. 2 is a schematic diagram of an embodiment of the interactive object system 10, wherein the schematic diagram demonstrates communication between the one or more interactive objects 20 and various components of the interactive object system 10 external to the one or more interactive objects 20. Disclosed techniques for detecting and/or locating the one or more interactive objects 20 as provided herein may utilize the one or more detectors 16, the object communication circuitry 24, the one or more detectable markers 25, the one or more haptic devices 26, the one or more identification models 30, the one or more communication devices 32, and/or the database 34.

As described herein, in operation with a single interactive object 20, the object communication circuitry 24 may provide RF signals to the one or more communication devices 32. Signal strength of the RF signals may indicate a position of the single interactive object 20, and the RF signals may also encode a unique identifier for the single interactive object 20. The one or more communication devices 32 may provide one or more indications of the signal strength of the RF signals and the unique identifier to the controller 18. The controller 18 may determine the position of the single interactive object 20 based on the one or more indications of the signal strength of the RF signals. Additionally or alternatively, the controller 18 may identify or select the single interactive object 20 as a best candidate interactive object based on the one or more indications of the signal strength of the RF signals and/or the unique identifier. Additionally or alternatively, the controller 18 may retrieve or access a user profile associated with the unique identifier.

In an embodiment, the controller 18 may carry out a write/read communication protocol to confirm presence of and/or proper identification of the single interactive object 20. Additionally or alternatively, the controller 18 may send an object-specific command based on the unique identifier to cause the single interactive object 20 to provide a detectable output, such as to cause one or more haptic devices 26 of the single interactive object 20 to provide haptic outputs (e.g., vibrations) that cause variations in the signal strength of the RF signals from the object communication circuitry 24 of the single interactive object 20.

As described herein, the single interactive object 20 may also include the one or more detectable markers 25. In an embodiment, the controller 18 may control the one or more light emitters 28 to emit light, which is then reflected by the one or more detectable markers 25 and is then detected by the one or more detectors 16. Thus, the signal strength of the RF signals and/or the reflected light may be utilized to detect, identify, tag (e.g., at a position; assign coordinates in the grid 40 mapped to the interactive environment 14 as shown in FIG. 1), and/or track movement of the single interactive object 20. For example, the signal strength of the RF signals may be utilized to detect, identify, and/or tag the single interactive object 20, and the reflected light may be utilized to track the movement of the single interactive object 20. As another example, the signal strength of the RF signals may be utilized to detect, identify, tag, and/or track the single interactive object 20, and the reflected light may be additionally utilized to track the movement of the single interactive object 20 (e.g., for confirmation and/or backup tracking of the single interactive object 20). Indeed, the controller 18 may switch between and/or adjust utilizing the signal strength of the RF signals and the reflected light for various purposes, such as to track the movement of the single interactive object 20.

As described herein, one or more identification models 30 may be generated and used to analyze the signal strength of the RF signals and/or the reflected light to detect, identify, tag, and/or track the single interactive object 20. For example, the controller 18 may input the signal strength of the RF signals over time into the one or more identification models 30, and the one or more identification models 30 may determine that the signal strength of the RF signals follow a certain pattern that corresponds to interest in carrying out interactions in the interactive environment 14 (e.g., dwell time at a target location; direct path to the target location). Thus, the controller 18 may detect, identify, and tag the single interactive device 20 to facilitate subsequent tracking of motion of the single interactive device 20 (e.g., via the signal strength of the RF signals and/or the reflected light).

As another example, the controller 18 may input the signal strength of the RF signals over time into the one or more identification models 30, and the one or more identification models 30 may determine that the signal strength of the RF signals follow a certain pattern that corresponds to a target motion of multiple target motions (e.g., a first pattern that corresponds to a swirl motion; a second pattern that corresponds to a swipe motion, and so forth). In this way, the controller 18 may identify successful or complete gestures or movements performed with the single interactive object 20. Further, because the controller 18 received the unique identifier, the controller 18 may assign accomplishments to the user profile and/or otherwise update the user profile, provide personalized special effects (e.g., special effect outputs) on-board the single interactive object 20 and/or via the external special effect system 60 based on the user profile, and so forth.

Importantly, the interactive object system 10 may enable the controller 18 to track the single interactive object 20 even when proximate to additional interactive objects 20 (e.g., within the range of the one or more communication devices 32 and/or the field of view of the one or more detectors 16). For example, even if the additional interactive objects 20 transmit signals toward the one or more communication devices 32 and/or reflect light toward the one or more detectors 16, the controller 18 will continue to identify and separately track the signals (e.g., the RF signal and/or the reflected light) from the single interactive object 20 since the single interactive object 20 has been initially selected and/or tagged as the best candidate interactive object (e.g., at least until another interactive object 20 is selected and/or tagged as a new best candidate interactive object).

As shown, an object controller 39 may control other components of the single interactive object 20. For example, the object controller 39 may control the object communication circuitry 24, which may be powered either passively (e.g., via power harvesting) or actively (e.g., by a power source 56). In the depicted embodiment, the object communication circuitry 24 may emit a wireless signal that communicates object identification information via a RFID tag, an infrared light signal, or the like. The object controller 39 may also be configured to receive control signals from the controller 18, such as via communication between the object communication circuitry 24 and the one or more communication devices 32. In this way, the object controller 39 may control the on-board devices to provide the one or more special effects and/or control the one or more haptic devices 26 to provide the one or more haptic outputs, for example.

It should be appreciated that the controller 18 may include one or more processors 50 and one or more memory devices 52. The one or more processors 50 may include one or more application specific integrated circuits (ASICs), one or more field programmable gate arrays (FPGAs), one or more general purpose processors, or any combination thereof. Additionally, the one or more memory devices 52 may include volatile memory, such as random access memory (RAM), and/or non-volatile memory, such as read-only memory (ROM), optical drives, hard disc drives, or solid-state drives. The controller 18 may include one or more controllers (e.g., in the interactive environment 14 (FIG. 1)) that communicate with each other through the use of a wireless mesh network (WMN) or other wireless and/or wired communication methods.

The controller 18 may be part of a distributed decentralized network of one or more controllers. The decentralized network of the one or more controllers may facilitate reduction in processing time and processing power required for the one or more controllers dispersed throughout one or more interactive environments 14 (FIG. 1). The decentralized network of the one or more controllers may be configured to obtain user profiles by requesting the user profiles from a profile feed stored in a central server. The user profile feed may include user accomplishments and/or other user profile information disclosed herein. The one or more controllers 18 may act as edge controllers that subscribe to a profile feed including multiple user profiles stored in the central server and cache the profile feed to receive one or more user profiles contained in the profile feed.

As described herein, additional controller(s) and/or processor(s) may be associated with (e.g., located on; housed within) other components. The additional controller(s) and/or processor(s) may facilitate edge processing to reduce latency, reduce power usage, and so forth. Together, the controller 18 (which may include one or more controllers), the processor 50 (e.g., which may include one or more processors), the memory device 52 (e.g., which may include one or more memory devices), the network of one or more controllers in the decentralized network, and/or the respective object controllers 39 of the one or more interactive objects 20 may carry out processing operations to carry out the techniques disclosed herein. It should be appreciated that “processing circuitry” and/or “control circuitry” as used herein may refer to any combination of these control and/or processing components, and the processing operations may be distributed in any suitable manner (e.g., one or more operations carried out by one processor of the processing circuitry, one or more other operations carried out by another processor of the processing circuitry, and so forth).

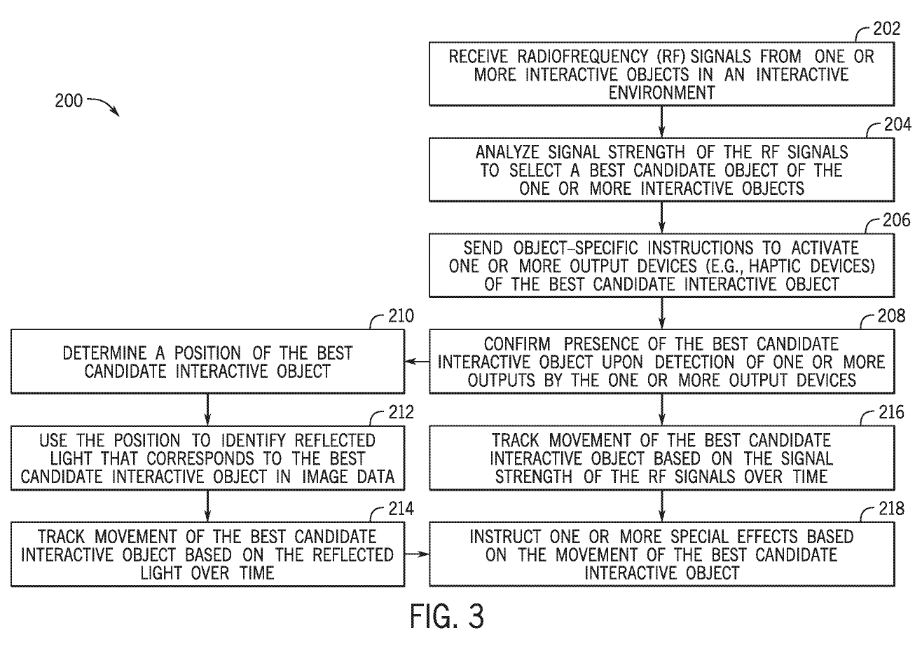

FIG. 3 is a flow diagram of an embodiment of a process 200 for detecting and tracking motion of an interactive object, in accordance with present techniques. The process 200 may be performed by processing circuitry or control circuitry, which may include the controller 18 of the interactive object system 10 disclosed above with reference to FIG. 1 and FIG. 2. Furthermore, the blocks of the process 200 may be performed in the order disclosed herein or in any suitable order. For example, certain blocks of the process may be performed concurrently. In addition, in an embodiment, at least one additional block may be added to the process 200 and/or at least one of the blocks of the process 200 may be omitted.

At block 202 of the process 200, the interactive object system 10 may receive radiofrequency (RF) signals from one or more interactive objects in an interactive environment. The interactive object system 10 may determine that one or more interactive objects are in the interactive environment based on communication between communication circuitry of the one or more interactive objects and communication circuitry coupled to a controller. Additionally or alternatively, in an embodiment, detection of the interactive objects in the interactive environment may be determined using optical measurements based on data collected by, for example, one or more cameras.

At block 204 of the process 200, the interactive object system 10 may analyze signal strength of the RF signals to select a best candidate object of the one or more interactive objects. In an embodiment, the best candidate object of the one or more interactive objects may be selected based on signal strength, signal strength for a threshold period of time, a pattern indicating a direct path of the best candidate object to a target location, or a combination thereof. Analysis of the RF signals and/or selection of the best candidate object may be determined using an identification model. The identification model may be a trained AI model.

At block 206 of the process 200, the interactive object system 10 may send object-specific instructions to activate one or more output devices (e.g., haptic devices) of the best candidate interactive object. Activation of the one or more output devices of the best candidate object may generate haptic effects (e.g., vibrations, tactile sensations). In an embodiment, the haptic effects may alert or notify a respective user that they have been selected by the interactive object system to proceed with an interactive experience.

At block 208 of the process 200, the interactive object system 10 may confirm presence of the best candidate interactive object upon detection of the one or more outputs by the one or more output devices. The haptic effects generated by the best candidate object may cause a change in a signal strength of the RF signals. As such, changes in the signal strength may be used to confirm presence of the best candidate interactive object in the interactive environment. In an embodiment, the identification model may be used to detect change in the signal strength of the RF signals to verify presence of the best candidate interactive object. For example, the best candidate interactive object may vibrate, thereby generating a change in RF signal strength and/or encoding a pattern within the RF signal. The identification model may be used to identify the change in the RF signal strength and/or the pattern using machine learning processes. The identification model may be trained using training data including changes in RF signal strength and/or patterns generated as a result of model outputs generated by model output devices.

The process 200 may proceed from block 208 to block 210. At block 210 of the process 200, the interactive object system 10 may determine a position of the best candidate interactive object. In an embodiment, the position may be determined based on the signal strength of transmission between the best candidate interactive object and the controller. For example, the signal strength of the best candidate interactive object may be compared to a threshold signal strength to determine if the best candidate interactive object is within a tracking area (e.g., the area) of the interactive environment. In an embodiment, the position of the best candidate interactive object may be determined based on image data of the best candidate interactive object within the interactive environment.

At block 212 of the process 200, the interactive object system 10 may use the position to identify reflected light that corresponds to the best candidate interactive object in image data. The interactive object system 10 may activate one or more emitters to emit light that corresponds to a retroreflector wavelength relevant to a respective detectable marker of the best candidate interactive object. The one or more emitters may be activated to emit the light within a specific spectral region, such as IR light matching the retroreflector wavelength. The respective detectable marker may include a retroreflector to reflect the light emitted by the one or more emitters. The reflected light may be reflected by one or more detectable markers of the best candidate interactive object. The reflected light may be detected by one or more sensors (e.g., detectors; cameras). For example, the position of the best candidate interactive object may be used to tag and confirm the best candidate interactive object in the image data. Then, one or more emitters in the interactive environment may emit light (e.g., IR light), which is then reflected by the respective detectable marker of the best candidate interactive object.

At block 214 of the process 200, the interactive object system 10 may track movement of the best candidate interactive object based on the signal strength of the reflected light over time. Analysis of the image data over time may indicate the motion of the best candidate interactive object (e.g., trails formed via reflection of the light indicate gestures or motions of the best candidate interactive object). For example, even if additional interactive objects reflect light, the interactive object system 10 may continue to identify and separately track the reflections (e.g., a trail of reflections during motion) from the best candidate interactive object based on the position derived from the image data and the signal strength of the light over time.

The process 200 may proceed from block 208 to block 216. At block 216 of the process 200, the interactive object system 10 may track movement of the best candidate interactive object based on the signal strength of the RF signals over time. In an embodiment, the identification model may be used to track movement of the best candidate interactive object. For example, the identification model may determine that the signal strength of the RF signals over time corresponds to (e.g., sufficiently matches, such as based on training data) a target movement of multiple available or known target movements. The target movement may correspond to one or more known patterns, series of gestures, and the like performed by users within the interactive environment. As such, the identification model may use known variations in signal strength of the RF signals over time to determine that the signal strength of the RF signals of the best candidate object correspond to a particular target movement.

In an embodiment, the interactive object system 10 may filter out one or more changes in signal strength of the RF signals as a result of environmental noise. Environmental noise may include cross interference, signal reflection, and the like as a result of data collection in real-world environments. For example, environmental noise may be present in the RF signals collected by the interactive object system 10 due to presence of one or more devices (e.g., phones, tablets, watches, Bluetooth enabled devices, etc.) within the interactive environment, interruption in signal transmission between the best candidate interactive object and the detector, and the like. For example, one source of environmental noise may include cross interference due to a wireless signal (e.g., Wi-Fi, Bluetooth, etc.), within the interactive environment. As such, the interactive object system 10 may filter for one or more frequency spectrums corresponding to the wireless signal to remove environmental noise from the RF signals.

In an embodiment in response to determining that the signal strength of the RF signal corresponds to the particular target movement, the interactive object system 10 may execute one or more special effects. In an embodiment, if the signal strength of the RF signals produced by the best candidate interactive object does not correspond to the target movement, the interactive object system 10 may continue to track movement of the best candidate interactive object. For example, the best candidate interactive object may be tracked until the movement is determined to correspond to the target movement. Additionally or alternatively, the best candidate interactive object may be tracked until the RF signals indicate absence of the best candidate interactive object (e.g., it has moved out of range and/or field of view), and/or a new best candidate is selected (e.g., due to a lapse of time and/or new RF signals detected for the new best candidate). It should be noted, the identification model may perform analysis of the RF signals in real-time to improve an immersive experience of the user as a result of use of the interactive objects within the interactive environment.

At block 218 of the process 200, the interactive object system 10 may instruct one or more special effects based on the movement of best candidate interactive object. Movement of the best candidate interactive object may be tracked using the signal strength of the reflected light over time, the RF signals over time, or a combination thereof. The one or more special effects may include special effects outputs customized based on experiences within the interactive environment. In an embodiment, one or more special effects (e.g., special effect outputs) may be provided on-board the best candidate interactive object and/or via the external special effect system. Further, the one or more special effects may account for details in the user profile. In this manner, the special effect outputs may support a particular narrative in the interactive environment.

The specific embodiments described above have been shown by way of example, and it should be understood that these embodiments may be susceptible to various modifications and alternative forms. For example, any features shown and described with respect to FIGS. 1-3 may be combined in any suitable manner. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function]…” or “step for [perform] ing [a function]…” it is intended that such elements are to be interpreted under 35 U.S.C. 112(f). However, for any claims containing elements designated in any other manner, it is intended that such elements are not to be interpreted under 35 U.S.C. 112(f).

1. An interactive object system, comprising:
processing circuitry comprising one or more processors; and
memory storing instructions, that when executed by the processing circuitry, cause the processing circuitry to:
receive, via one or more communication devices, tag data indicative of signal strength of radiofrequency signals transmitted by object communication circuitry of an interactive object;
determine, via an identification model, a position of the interactive object in an interactive environment based on the tag data; and
track, via the identification model, motion of the interactive object based on the tag data.

2. The interactive object system of claim 1, wherein the instructions, when executed by the processing circuitry, cause the processing circuitry to:
provide output instructions to generate one or more special effect outputs based on the motion of the interactive object.

3. The interactive object system of claim 2, wherein the tag data is indicative of a unique identifier of the interactive object, and the instructions, when executed by the processing circuitry, cause the processing circuitry to:
access a profile associated with the interactive object based on the identifier; and
provide the output instructions to generate the one or more special effect outputs based on the motion of the interactive object and the profile.

4. The interactive object system of claim 1, wherein the one or more communication devices comprises one or more radiofrequency (RFID) readers, and the object communication circuitry comprises a RFID tag.

5. The interactive object system of claim 1, wherein the one or more communication devices comprises multiple communication devices, and the tag data is indicative of the signal strength of the radiofrequency signals with respect to the multiple communication devices.

6. The interactive object system of claim 1, wherein the instructions, when executed by the processing circuitry, cause the processing circuitry to:
identify, via the identification model, one or more patterns in the signal strength of the radiofrequency signals over time to track the motion of the interactive object based on the tag data.

7. The interactive object system of claim 6, wherein the instructions, when executed by the processing circuitry, cause the processing circuitry to:
identify, via the identification model, that the one or more patterns in the signal strength of the radiofrequency signals over time correspond to performance of a target motion by the interactive object.

8. The interactive object system of claim 1, wherein the instructions, when executed by the processing circuitry, cause the processing circuitry to:
detect a presence of a plurality of interactive objects in the interactive environment, wherein the plurality of interactive objects comprises the interactive object as a first interactive object of the plurality of interactive objects;
identify the first interactive object of the plurality of interactive objects as a best candidate object of the plurality of interactive objects in the interactive environment based on the tag data; and
send, in response to identifying the first interactive object of the plurality of interactive objects as the best candidate object of the plurality of interactive objects, object-specific instructions to the first interactive object of the plurality of interactive objects to cause a respective output device of the first interactive object of the plurality of interactive objects to provide an output without causing any respective output devices of a remainder of the interactive objects of the plurality of interactive objects to provide respective outputs.

9. The interactive object system of claim 8, wherein the output device comprises a haptic device.

10. The interactive object system of claim 8, wherein the instructions, when executed by the processing circuitry, cause the processing circuitry to:
confirm that the first interactive object of the plurality of interactive objects is properly identified as the best candidate interactive object of the plurality of interactive objects based on the tag data indicating a change in the signal strength of the radiofrequency signals during the output.

11. The interactive object system of claim 1, wherein the instructions, when executed by the processing circuitry, cause the processing circuitry to:
identify, in image data generated by one or more detectors, light reflected by the interactive object based on the position of the interactive object in the interactive environment; and
track, using the image data, the motion of the interactive object based on the light reflected by the interactive object.

12. The interactive object system of claim 1, comprising the interactive object, wherein the interactive object comprises a handheld object.

13. A method of operating an interactive object system, the method comprising:
receiving, at one or more processors and via one or more communication devices, tag data indicative of signal strength of radiofrequency signals transmitted by object communication circuitry of an interactive object;
tracking, via the one or more processors and using an identification model, motion of the interactive object based on the tag data; and
providing, via the one or more processors, output instructions to generate one or more special effect outputs based on the motion of the interactive object.

14. The method of claim 13, comprising:
receiving, at the one or more processors and via the one or more communication devices, a unique identifier from the interactive object;
accessing, via the one or more processors, a profile associated with the interactive object based on the unique identifier; and
providing, via the one or more processors, the output instructions to generate the one or more special effect outputs based on the motion of the interactive object and information in the profile.

15. The method of claim 13, comprising:
identifying, via the one or more processors and using the identification model, one or more patterns in the signal strength of the radiofrequency signals over time to track the motion of the interactive object based on the tag data.

16. The method of claim 13, comprising:
detecting, via the one or more processors, presence of a plurality of interactive objects in an interactive environment, wherein the plurality of interactive objects comprises the interactive object as a first interactive object of the plurality of interactive objects;
identifying, via the one or more processors, the first interactive object of the plurality of interactive objects as a best candidate object of the plurality of interactive objects in the interactive environment based on the tag data; and
sending, via the one or more processors and in response to identifying the first interactive object of the plurality of interactive objects as the best candidate object of the plurality of interactive objects, object-specific instructions to the first interactive object of the plurality of interactive objects to cause a respective output device of the first interactive object of the plurality of interactive objects to provide an output that is configured to change the signal strength of the radiofrequency signals during the output.

17. The method of claim 13, comprising:
determining, via the one or more processors, a position of the interactive object in an interactive environment based on the tag data;
identifying, via the one or more processors and in image data generated by one or more detectors, light reflected by the interactive object based on the position of the interactive object in the interactive environment; and
tracking, via the one or more processors and using the image data, the motion of the interactive object based on the light reflected by the interactive object.

18. The method of claim 17, comprising:
determining, via the one or more processors, occurrence of a condition associated with the interactive environment; and
blocking the tracking, via the one or more processors and using the image data, of the motion of the interactive object based on the light reflected by the interactive object during the occurrence of the condition.

19. An interactive object system, comprising:
an interactive object comprising an object communication device;
processing circuitry comprising one or more processors; and
memory storing instructions that, when executed by the processing circuitry, cause the processing circuitry to:
determine signal strength of radiofrequency signals transmitted by the object communication device of the interactive object and received at one or more communication devices in an interactive environment;
input the signal strength of the radiofrequency signals into an identification model to track motion of the interactive object; and
provide output instructions to generate one or more special effect outputs based on the motion of the interactive object.

20. The interactive object system of claim 19, wherein the identification model is trained to identify one or more patterns in the signal strength and to correlate the one or more patterns in the signal strength to one or more target motions to track the motion of the interactive object.
